(19) United States
(12) Patent Application Publication
(10) Pub. No.: US 2013/0275850 A1
(43) Pub. Date: Oct. 17, 2013

(54) AUTONOMIC VISUAL EMPHASIS OF PREVIEWED CONTENT

(71) Applicants: Gary D. Cudak, Creedmoor, NC (US); Christopher J. Hardee, Raleigh, NC (US); Randall C. Humes, Raleigh, NC (US); Adam Roberts, Moncure, NC (US)

(72) Inventors: Gary D. Cudak, Creedmoor, NC (US); Christopher J. Hardee, Raleigh, NC (US); Randall C. Humes, Raleigh, NC (US); Adam Roberts, Moncure, NC (US)

(73) Assignee: International Business Machines Corporation, Armonk, NY (US)

(21) Appl. No.: 13/447,147

(22) Filed: Apr. 13, 2012

(51) Int. Cl. G06F 17/21; G06F 17/00

(52) U.S. Cl. 715/234; 715/256

(57) ABSTRACT

Embodiments of the present invention provide a method, system and computer program product for the visual emphasis of previously viewed content. In an embodiment of the invention, a method for visual emphasis of previously viewed content has been provided. The method can include identifying an end user viewing content loaded in a content reader executing in memory of a computer and tracking a gaze of the end user to determine a portion of the content viewed by the end user. The method also includes storing a reference to the portion of the content in a data store in connection with the identified end user. Finally, the method can include subsequently responding to a re-loading of the content in the content reader by the end user by visually emphasizing the portion of the content referenced in the data store.

### BACKGROUND OF THE INVENTION

1. Field of the Invention

The present invention relates to document review and more particularly to visual emphasis of previously viewed content.

2. Description of the Related Art

The global Internet has facilitated the dissemination of mass quantities of documentation. In the first instance, the World Wide Web provides an instantaneous mechanism for publishing documents including text, imagery and even audiovisual material. Additionally, through the Internet medium, electronic forms of communication allow for messaging supporting document exchanges in the form of “document attachments”. As a consequence of the “document attachment” feature afforded by Internet based messaging, the ability of individuals to collaboratively review and edit a document likewise has become common and frequent.

For an individual, reviewing a large number of documents over a period of time can be challenging. In particular, when reviewing the same document repeatedly over time, the individual can re-read the same portions of the document resulting in substantial inefficiencies. Further, for a document that has been collaboratively edited, the individual can read portions of the document not yet of concern to the exclusion of other portions of the document that have been the subject of review for some time.

For individuals who frequently review documents in a collaborative editing environment, “red line” or “black line” tools allow an individual to visually detect changes, deletions and additions to a document subject to collaborative review. However, such tools only act upon actual edits by a collaborator and bear no relationship to the mere act of reviewing a document. Further, highlighting tools exist both alone and as part of word processors in order to provide the individual with a way to mark portions of a document of interest for future reference. However, the use of highlighting tools requires a manual intervention on the part of the end user and thus lacks the automated characteristic requisite to provide an autonomic visual emphasis of material already reviewed by an end user.

### BRIEF SUMMARY OF THE INVENTION

Embodiments of the present invention address deficiencies of the art in respect to document review and provide a novel and non-obvious method, system and computer program product for the visual emphasis of previously viewed content. In an embodiment of the invention, a method for visual emphasis of previously viewed content has been provided. The method can include identifying an end user viewing content loaded in a content reader executing in memory of a computer and tracking a gaze of the end user to determine a portion of the content viewed by the end user. The method also includes storing a reference to the portion of the content in a data store in connection with the identified end user. Finally, the method can include subsequently responding to a re-loading of the content in the content reader by the end user by visually emphasizing the portion of the content referenced in the data store. In one aspect of the embodiment, the method can additionally include comparing different portions of the re-loaded content to portions referenced in the data store and visually emphasizing only those of the different portions that include a threshold number of words that match corresponding portions referenced in the data store.

In another embodiment of the invention, a data processing system can be configured for visual emphasis of previously viewed content. The system can include a host computer with at least one processor and memory and a content reader executing in the memory of the host computer. The system also can include an eye tracker coupled to the host computer. Finally, the system can include an automated visual emphasis module the includes program code executing in the memory of the computer. The program code identifies an end user viewing content loaded in the content reader, receives from the eye tracker a reference to a portion of the content viewed by the end user, stores the reference to the portion of the content in a coupled data store in connection with the identified end user, and subsequently responds to a re-loading of the content in the content reader by the end user by directing a visually emphasis of the portion of the content referenced in the data store.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for visual emphasis of previously viewed content;

FIG. 2 is a schematic illustration of a document reviewing data processing system configured for visual emphasis of previously viewed content; and,

FIG. 3 is a flow chart illustrating a process for visual emphasis of previously viewed content.

### DETAILED DESCRIPTION OF THE INVENTION

Embodiments of the invention provide for visual emphasis of previously viewed content. In accordance with an embodiment of the invention, gaze tracking can be employed to track the gaze of an end user viewing a document. A portion of the document corresponding to the tracked gaze can be recorded by reference in a data store, optionally in association with the end user. Subsequently, when the document is loaded for viewing by the end user, the data store can be consulted and portions referenced in the data store in association with the end user can be visually distinguished to indicate that the end user had previously viewed the visually distinguished portions of the document.

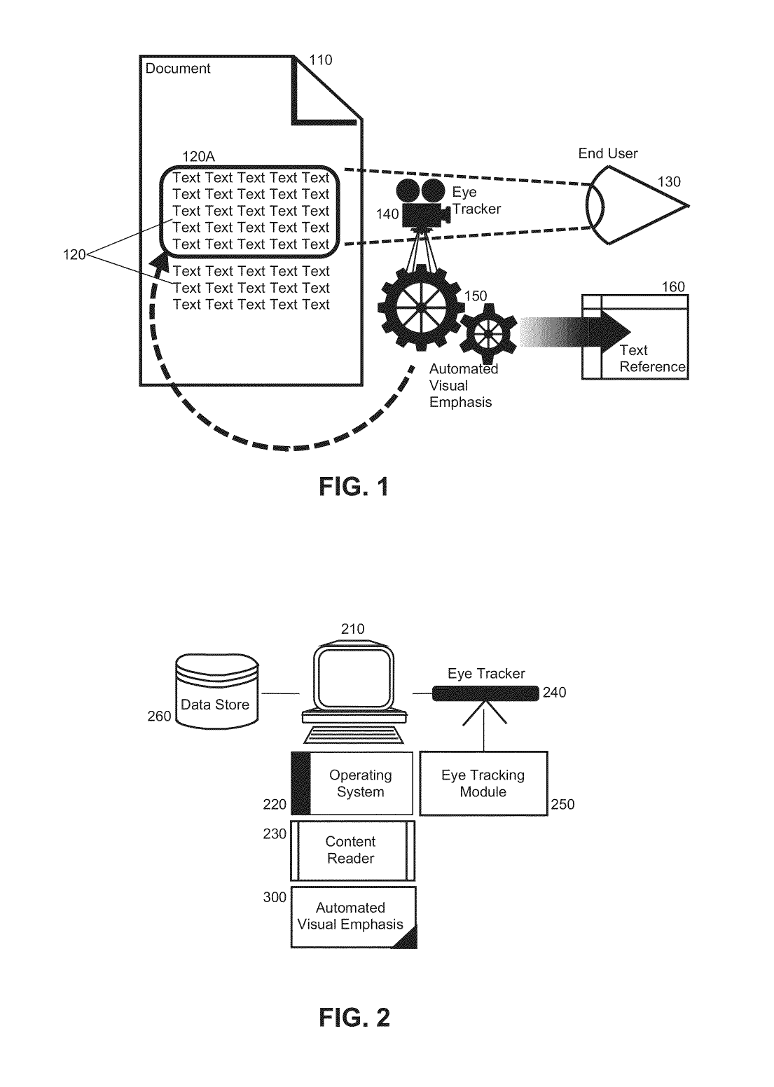

In further illustration, FIG. 1 pictorially shows a process for visual emphasis of previously viewed content. As shown in FIG. 1, an end user 130 can view a document 110 that includes content 120, whether text, imagery or otherwise. An eye tracker 140 can track the portion 120A of the content 120 of the document 110 viewed by the end user 130. An automated visual emphasis process 150 can note the identity of the end user 130, the document 110 and the portion 120A in a table 160. Thereafter, when loading a document 110, the automated visual emphasis process 150 can compare the document 110 to the table 160 to identify the portion 120A of the content 120 previously viewed by the end user 130. As such, the automated visual emphasis process 150 can visually emphasize the portion 120A of the document 110 so that the end user 130 can readily identify which of the content 120 has been previously viewed and which of the content 120 has not been previously viewed.

The process described in connection with FIG. 1 can be implemented within a document reviewing data processing system. To wit, FIG. 2 is a schematic illustration of a document reviewing data processing system configured for visual emphasis of previously viewed content. The system can include a host computer 210 that includes at least one processor and memory. The host computer 210 can support the execution of an operating system 220 which in turn can host the operation of a content reader 230 in which content can be viewed such as the content of a document. In particular, as used herein, a “document” can include any textual file that ranges from a word processing document to a Web page.

An eye tracker 240 can be coupled to the host computer 210 and configured to locate points on a display of the host computer 210 consistent with the gaze of an end user viewing a document displayed in the content reader 230 of the host computer 210. An eye tracking module 250 coupled to the eye tracker and executing through the operating system 220 can provide to an automated visual emphasis module 300 location data pertaining to the gaze of the end user as acquired by the eye tracker 240. In this regard, the automated visual emphasis module 300 can execute in the operating system 220 and process the location data in concert with the display of content in the content reader 230.

Specifically, the automated visual emphasis module 300 can include program code stored in a storage medium such as a fixed disk that when executed in the memory of the host computer 210 can respond to the loading of a document for viewing in the content reader 230 by processing the location data returned by the eye tracking module 250 in respect to a particular end user viewing the document in the content reader 230 and the portions of the document viewed by the end user can be stored by the program code in data store 260. Concurrently, the program code of the automated visual emphasis module 300 can determine from the data store 260 whether or not the document had been previously viewed by the end user and if so, the portions of the document known to have been previously viewed as recorded in the data store 260 can be visually emphasized in the content reader 230, such as for example highlighting text in the previously viewed portions, altering a font characteristic of the text in the previously viewed portions, or otherwise demarcating the text in the previously viewed portions.

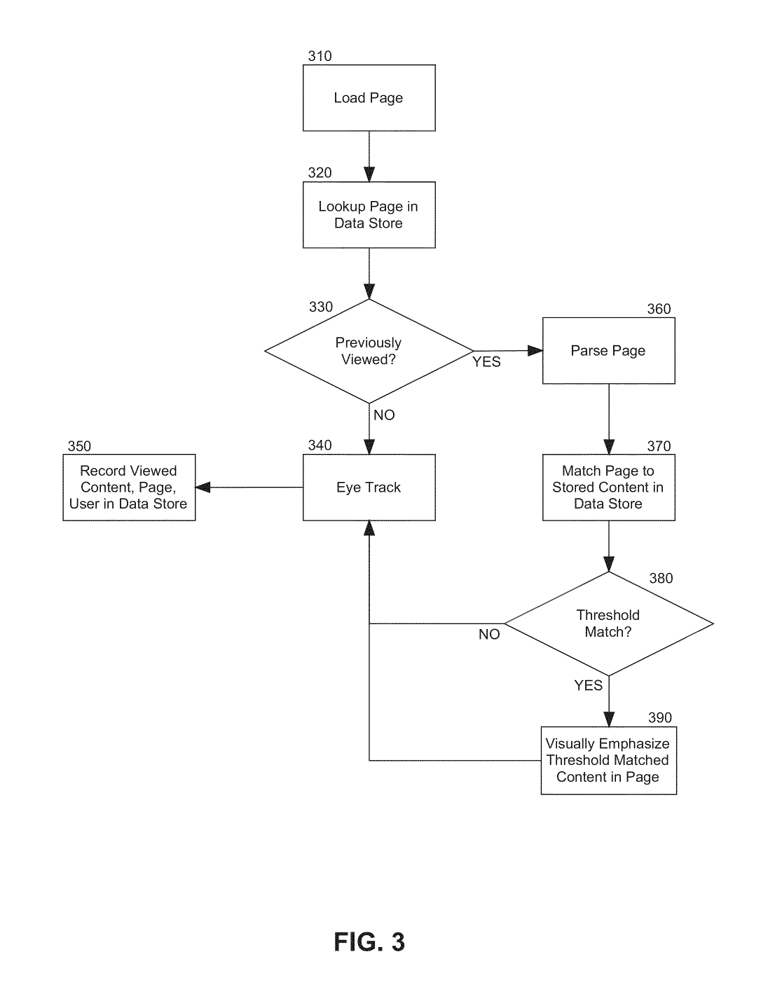

In even yet further illustration of the operation of the automated visual emphasis module 300, FIG. 3 is a flow chart illustrating a process for visual emphasis of previously viewed content. The process can begin in block 310 with the loading on behalf of an end user of content in a content reader, such as a Web page in a Web browser. In block 320, the data store can be consulted to determine in decision block 330 whether the content had been previously viewed in the content reader by the end user. If so, in block 360 the content can be parsed and portions of the parsed content compared in block 370 compared to portions of content stored in the data store in connection with the content.

In decision block 380, if a threshold number of words of the compared portions match, it can be concluded that the compared portions had been previously viewed by the end user. As such, in block 390 the portion within the content that compares with that of the data store can be visually emphasized in the content reader. Thereafter, in block 340, the portions of the content subject to the gaze of the end user can be tracked in the data store in connection with the content and the end user. Finally, in block 350 the tracked portions of the content viewed by the end user and tracked according to the gaze of the end user can be stored in the data store for subsequent retrieval.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for visual emphasis of previously viewed content, the method comprising:
identifying an end user viewing content loaded in a content reader executing in memory of a computer;
tracking a gaze of the end user to determine a portion of the content viewed by the end user;
storing a reference to the portion of the content in a data store in connection with the identified end user; and,
subsequently responding to a re-loading of the content in the content reader by the end user by visually emphasizing the portion of the content referenced in the data store.

2. The method of claim 1, further comprising:
comparing different portions of the re-loaded content to portions referenced in the data store; and,
visually emphasizing only those of the different portions that include a threshold number of words that match corresponding portions referenced in the data store.

3. The method of claim 1, wherein the content reader is a Web browser and the content is a Web page.

4. The method of claim 1, wherein the content reader is a word processor and the content is a document.

5. A data processing system configured for visual emphasis of previously viewed content, the system comprising:
a host computer with at least one processor and memory;
a content reader executing in the memory of the host computer;
an eye tracker coupled to the host computer; and,
an automated visual emphasis module comprising program code executing in the memory of the computer, the program code identifying an end user viewing content loaded in the content reader, receiving from the eye tracker a reference to a portion of the content viewed by the end user, storing the reference to the portion of the content in a coupled data store in connection with the identified end user, and subsequently responding to a re-loading of the content in the content reader by the end user by directing a visually emphasis of the portion of the content referenced in the data store.

6. The system of claim 5, wherein the program code of the automated visual emphasis module further compares different portions of the re-loaded content to portions referenced in the data store and visually emphasizes only those of the different portions that include a threshold number of words that match corresponding portions referenced in the data store.

7. The system of claim 5, wherein the content reader is a Web browser and the content is a Web page.

8. The system of claim 5, wherein the content reader is a word processor and the content is a document.

9. A computer program product for visual emphasis of previously viewed content, the computer program product comprising:
a computer readable storage medium having computer readable program code embodied therewith, the computer readable program code comprising:
computer readable program code for identifying an end user viewing content loaded in a content reader executing in memory of a computer;
computer readable program code for tracking a gaze of the end user to determine a portion of the content viewed by the end user;
computer readable program code for storing a reference to the portion of the content in a data store in connection with the identified end user; and,
computer readable program code for subsequently responding to a re-loading of the content in the content reader by the end user by visually emphasizing the portion of the content referenced in the data store.

10. The computer program product of claim 9, further comprising:
computer readable program code for comparing different portions of the re-loaded content to portions referenced in the data store; and,
computer readable program code for visually emphasizing only those of the different portions that include a threshold number of words that match corresponding portions referenced in the data store.

11. The computer program product of claim 9, wherein the content reader is a Web browser and the content is a Web page.

12. The computer program product of claim 9, wherein the content reader is a word processor and the content is a document.
